(19) United States
(12) Patent Application Publication
(10) Pub. No.: US 2007/0115959 A1
(43) Pub. Date: May 24, 2007

(54) Method and system for quiet time

(76) Inventors: Jason M. Parker, San Antonio, TX (US); Herman Rodriguez, Austin, TX (US)

Correspondence Address: IBM CORPORATION (SWP), C/O SUITER SWANTZ PC LLO, 14301 FNB PARKWAY, SUITE 220, OMAHA, NE, 68154-5299, US

(21) Appl. No.: 11/250,020

(22) Filed: Oct. 13, 2005

(51) Int. Cl. H04L 12/56

(52) U.S. Cl. 370/389; 370/401

(57) ABSTRACT

A method and system for creating a quiet zone. In an exemplary embodiment, the method includes receiving a request for the creation of the quiet zone and generating a quiet time data packet. The quiet time data packet may be generated by a source system and includes data specifying the start and duration of the quiet time. The quiet time data packet is transmitted from the source system to at least one destination system. Upon receipt of the quiet time data broadcast, the at least one destination system implements a quiet time for the specified duration within the destination system environment.

### FIELD OF THE INVENTION

The present invention generally relates to the field of communications, and more particularly to a method and a system for providing a quiet time designation to multiple devices such as a personal digital assistant (PDA), a computer, a telephone, pager, intercom, alarm clock, front-door buzzer, and the like.

### BACKGROUND OF THE INVENTION

A variety of methods are currently employed by individuals to facilitate communications in both personal and business settings. People have employed conventional communication devices such as the landline telephone to communicate with each other for many years now. The last decade has been marked by a vast increase in the number of devices employed by individuals to communicate in a variety of settings. Currently, individuals employ mobile devices such as cellular phones, pagers, instant messaging, email, and PDA's to communicate. For example, a PDA may function as a cellular phone, a fax sender, email sender and receiver in addition to a personal organizer.

Although the proliferation in communication devices has greatly increased the ability as well as the efficiency in which individuals may communicate, such devices are limited by the inability of the user to control the manner in which communications are received. For example, with the increased use of communication devices such as mobile phones, pagers, email alarms, instant messages, PDAs, and calendar reminders, it has become a challenge for a user to find quiet time in the office, at home as well as in a public setting such as a movie theater, playhouse, or park. While at the office, the constant interruption of these devices may detract from overall productivity due to the inability to fully focus on a single task. Further, the situation at home may be no less burdensome since time that may have been set aside for a quiet session is often hampered by an incoming phone call, page, text message or automated reminder, clock alarms or even the ringing of the front door bell. In addition, the viewing of a play, movie or even a walk in the park is often interrupted by the ringing of a wireless device.

Therefore, it would be desirable to provide a method and system which may address the aforementioned problems.

### SUMMARY OF THE INVENTION

In a first aspect of the invention, a method for creating a quiet zone by use of a global do not disturb designation is provided. In the present aspect, the method includes receiving by a source system a request for creating the quiet zone and generating a quiet time data packet. The quiet time data packet may be generated by the source system and includes data regarding quiet time duration. The quiet time data packet is broadcasted from the source system to at least one destination system. Upon receipt of the quiet time data broadcast, the at least one destination system implements the quiet time for the set duration within the destination system environment.

In a further aspect of the present invention, a computer program product including a computer useable medium having computer usable program code for creating a quiet zone is disclosed. In accordance with an exemplary aspect, the computer program product includes computer usable program code for receiving a request for creating the quiet zone. Further, the product includes computer usable program code for generating a quiet time data packet. The request may be received and the quiet time data packet generated by a source system. Further, the quiet time data packet includes data regarding quiet time duration. In addition, computer usable program code for broadcasting the quiet time data packet to at least one destination system is included. Moreover, computer usable program code for receiving the quiet time data packet by the at least one destination system is included so that the at least one destination system may implement the quiet time for the set duration.

In an additional aspect of the present invention, a system capable of creating a quiet zone by use of a global do not disturb designation is provided. In accordance with an exemplary aspect, the system includes a source system for generating a quiet time data packet. Further, at least one destination system is communicatively coupled to the source system for allowing the source system to put the at least one destination system into a quiet time mode. In such aspect, the quiet time data packet is generated by the source system and includes data regarding quiet duration. The source system broadcasts the quiet time data packet to the at least one destination system upon entry of a single request for quiet time to the source system.

It is to be understood that both the foregoing general description and the following detailed description are exemplary and explanatory only and are not necessarily restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is a flow diagram illustrating a method of creating a quiet zone for a user in accordance with an exemplary embodiment of the present invention, wherein a source system generates and sends a quiet time packet to various destination systems to put such systems into a “do not disturb” mode;

FIG. 2 is a flow diagram illustrating an additional method of creating a quiet zone for a user in accordance with an exemplary embodiment of the present invention, wherein the quiet zone may be ended by a source system sending a cancellation packet;

FIG. 3 is a flow diagram illustrating a further method of creating a quiet zone for a user in accordance with an exemplary embodiment of the present invention, wherein the user requests a quiet time broadcast which is then sent to various destination systems via a network protocol;

FIG. 4 is a flow diagram illustrating another method of creating a quiet zone for a user in accordance with an exemplary embodiment of the present invention, wherein the source system is a television provider; and

FIG. 5 is a block diagram illustrating a system for creating a quiet zone for a user in accordance with an exemplary embodiment of the present invention, wherein a source system implements a quiet zone in various destination systems via use of a quiet time data packet.

### DETAILED DESCRIPTION OF THE INVENTION

Reference will now be made in detail to the presently preferred embodiments of the invention, examples of which are illustrated in the accompanying drawings.

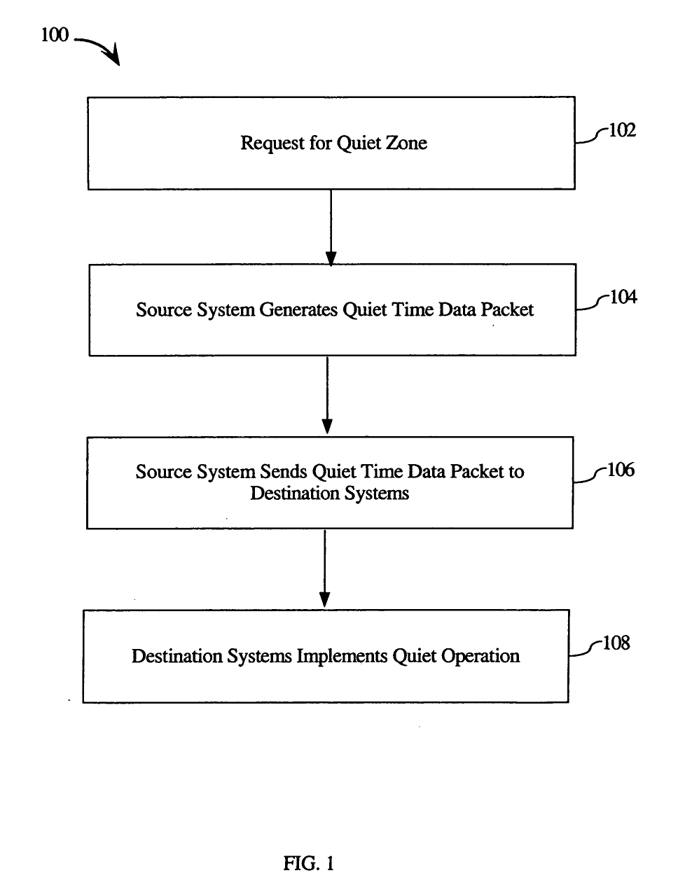

Referring to FIG. 1, a method 100 for creating a quiet zone by use of a global do not disturb designation is provided. In an embodiment, the method includes requesting the creation of the quiet zone 102 and a source system generating a quiet time data packet. The source system may be a computer, PDA, telephone, on-line service provider, remote device such as a key chain or television remote, and the like devices. Further, the quiet time packet may include data regarding quiet time destination and duration (e.g., start and stop of quiet time period). In an additional embodiment, the quiet time packet includes a user specific identification code which may be recognized by the destination system in order to protect the destination system from unauthorized access. The quiet time data packet is broadcasted or emitted from the source system to at least one destination system 106. Upon receipt of the quiet time data broadcast, the at least one destination system implements the quiet time for the set duration within the destination system environment 108. For example, the quiet time duration is set for thirty minutes starting now. Upon implementation of the quiet time, in such example, the destination system is in a do not disturb mode for thirty minutes starting now.

In an exemplary embodiment, the request for a quiet zone is made by a user making a manual entry of such request into the source system such as a computer system. In such embodiment, a user enters a request for the creation of a quiet zone, the computer then processes the request and generates a quiet time data packet. The quiet time packet may then be sent to a number of destination systems which are communicatively coupled by a communication network. For example, the quiet time packet may be sent to networked devices including, but not limited to a computer, a telephone (wired and wireless), a pager, a PDA, an intercom, a front-door buzzer, an alarm clock, and the like. Upon receipt of the quiet time data packet, each device sets the appropriate mode where disruptions are minimized or eliminated. For example, the front-door bell light may toggle on/off (e.g., blink) to denote the request for “quiet” time from any visitor, but it may still buzz if depressed. On the other hand, the telephone may forward all calls to voicemail, the pager may enter into a vibrate mode, and the PDA may disable the sound. Such configuration allows a user to put a number of devices into a “do not disturb” mode by a single entry into the source system. Although it is contemplated that the source system which sends the quiet time data packets may be a computer system, other devices with network capabilities such as a network router may also serve as the source system.

In an additional embodiment, a device such as a key-chain that emits RF or infrared communications is employed to trigger the commencement of a quiet time. For example, such device may commence a quiet time for a pre-set duration of time (e.g., thirty minutes). In such embodiment, a corresponding receiver may receive, process, and relay the quiet request to other devices that may be networked through wired or wireless technologies. In a further embodiment, several quiet time data packets may be instructed to initiate several quiet times at different times and for different durations.

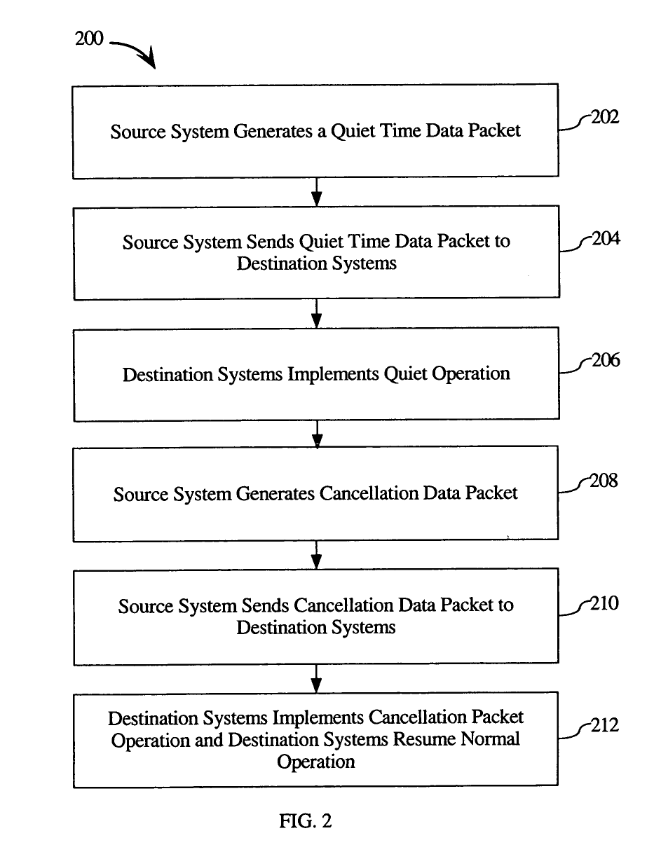

Referring to FIG. 2, an additional method of creating a quiet zone for a user in accordance with an exemplary embodiment of the present invention is provided in which the quiet zone may be ended by a source system sending a cancellation packet. In the present embodiment, a method 200 includes a source system generating a quiet time data packet 202. Such packet may be generated upon the source system receiving a request from the user or an automated function (e.g., a request generated automatically by a user's calendar/PIM application). Following the generation of the quiet time data packet, the source system sends such packet to the desired destination systems 204. As previously described, the destination systems may be diverse ranging from a computer to a front-door buzzer. Upon receipt of the quiet time data packet, the various destination systems implement the quiet time for the designated time period 206. However, the duration of the quiet time may be prematurely terminated by the source system. In the present method, the source system may prematurely terminate the quiet time by generating a cancellation data packet 208. Such packet includes information which instructs the destination systems to cancel the quiet time period. The cancellation of the quiet time is implemented by the source system sending the cancellation packet to the destination systems 210 and then, the destination systems implementing the instructions of the cancellation packet resulting in the destination systems resuming normal operation.

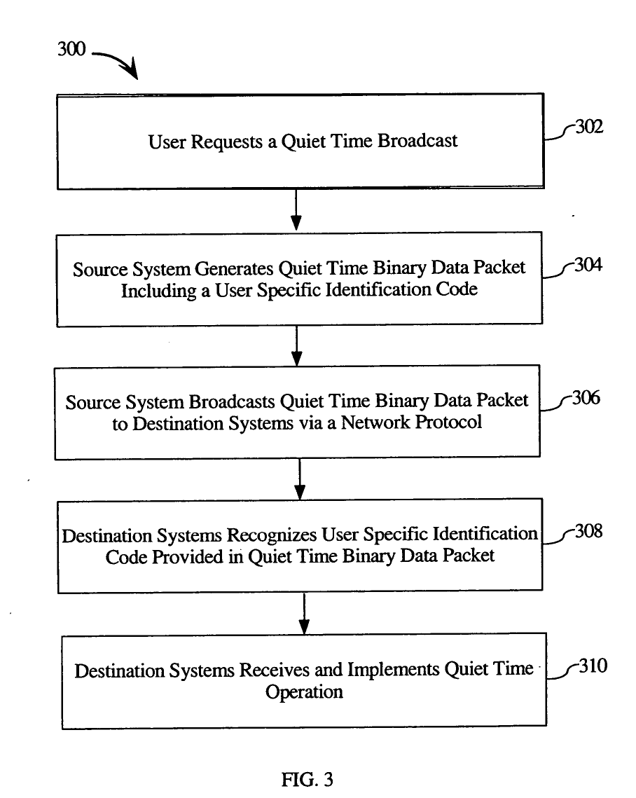

Referring to FIG. 3, a further exemplary method 300 of creating a quiet zone for a user is disclosed in which the method 300 includes a source system generating a quiet time binary data packet 304 and the packet being sent to the various destination devices via use of a network protocol 306. First, in the present embodiment, a user requests a quiet time broadcast by a manual entry into the source system 302. It is contemplated that the request may also be automatically generated by a user's calendar/PIM application, an on-line service provider, or the like. Upon the request, the source system generates a quiet time binary data packet 304. In an embodiment, the quiet time data packet includes information such as the start and stop duration of quiet time as well as a user specific identification code. The use of the user specific identification code protects the destination device from receiving unauthorized instructions/commands. The source system then broadcasts the quiet time binary data packet to the destination systems via use of a network protocol 306. For example, a Bluetooth message is sent to all paired Bluetooth devices to request the quiet operation. The destination systems recognizes the user specific identification code included within the quiet time binary data packet 308 and then, implements the quiet time according to the packet instructions 310. A sample panel setting indicating the start or stop of a quiet time duration may be utilized to inform a user of the current device mode.

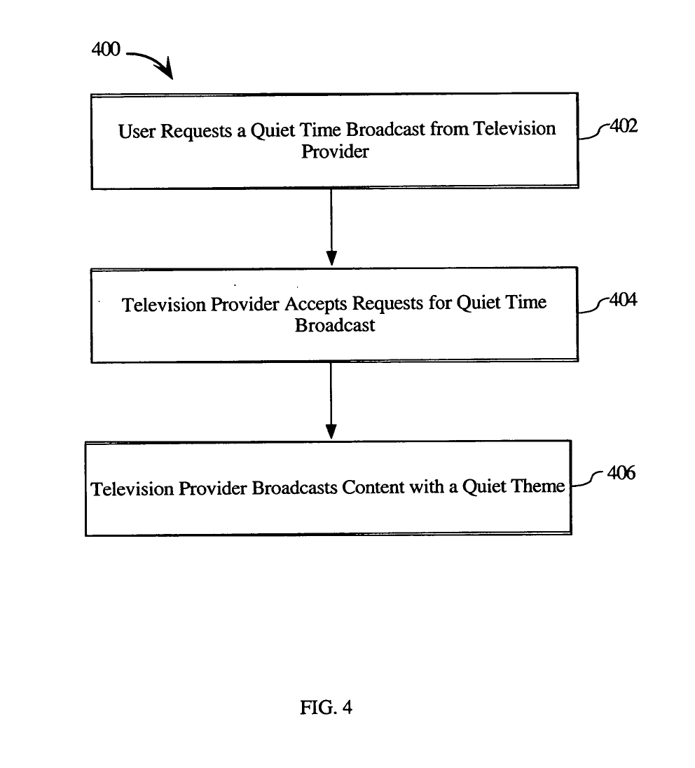

Referring to FIG. 4, another method 400 of creating a quiet zone for a user in accordance with an exemplary embodiment of the present invention is provided in which the source system is a television service provider. In method 400, the user requests a quiet time broadcast from a television service provider 402. For example, as a service to customers, a cable television provider may allow customers to limit the available content displayed on their television to content conducive to quiet time. The television service provider may accept the quiet request from a customer/subscriber 404 and as a result, broadcast television content with a quiet theme to the customer/subscribers television receiver. For example, the provider may broadcast a quiet time theme or limit the channel selection to only channels conducive to quiet time. Although the present method discloses the use of a television service provider to create a quiet time theme, it is contemplated that other themes such as “happy”, “melancholic”, “vibrant”, and the like may be created without departing from the spirit and scope of the present invention. For example, a “happy” theme may include comedy-based television content. In the alternative, a “melancholic” theme may include drama, or musical content provided by the television service provider which is melancholic.

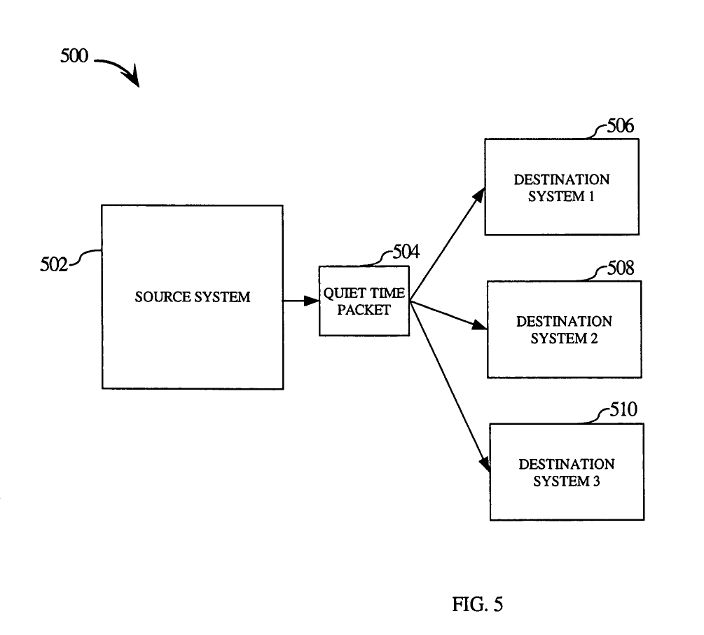

Referring to FIG. 5, a system 500 capable of creating a quiet zone by use of a global do not disturb designation is provided. In accordance with an exemplary embodiment, the system 500 includes a source system 502 for generating a quiet time data packet. Upon receiving a quiet time request, the source system 502 generates a quiet time data packet 504. The source system 502 may be a computer, PDA, on-line service provider/receiver, remote device such as a key chain or television remote control, and the like devices. Further, the source system 502 and receiving systems may be secured from unauthorized entry by use of standard security protocols including, but not limited to, passwords or codes, use of certificates, caller-identification, security tokens, and like protocols. In an embodiment, the quiet time data packet 504 includes data regarding quiet time duration. It is contemplated that the packet 504 may include additional data including a user specific identification code which may be recognized by a destination system which protects the destination system from unauthorized entry. Following the generation of the quiet time data packet 504, the source system 502 broadcasts the quiet time data packet 504 to the at least one destination system which is communicatively coupled to the source system for allowing the source system 502 to put the at least one destination system into a quiet time mode. Upon expiration of the quiet period, all of the subject devices resume normal operation. It is contemplated that the quiet time may be prematurely ended by the source system 502 sending a cancellation packet to the various destination systems. Receipt of the cancellation packet by the various destination systems causes such systems to cancel the quiet time and resume normal operations. Several quiet time data packets may be instructed to initiate several quiet times at different times and for different durations.

As illustrated in FIG. 5, the source system 502 sends a quiet time data packet 504 to a first destination system 506, a second destination system 508, and a third destination system 510. In an embodiment, the destination systems are paired Bluetooth devices. In an additional embodiment, the destination systems are registered devices on an on-line service. For example, a “quiet time” on-line service provider receives a quiet time request (e.g., via the Internet or telephone to a set top box) which it then implements by broadcasting or transmitting the quiet request to other on-line registered devices and services. In a further embodiment, the instructions for quiet time may be included within a media such as DVD, a TV broadcast signal, a caller ID record, and the like.

It is contemplated that the invention may take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention may take the form of a computer program product accessible from a computer-usable or computer-readable medium providing program code for use by or in connection with a computer or any instruction execution system. For the purposes of this description, a computer-usable or computer readable medium may be any apparatus that may contain, store, communicate, propagate, or transport the program for use by or in connection with the instruction execution system, apparatus, or device.

It is further contemplated that the medium may be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements may include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, microphone, speakers, displays, pointing devices, and the like) may be coupled to the system either directly or through intervening I/O controllers.

Network adapters may also be coupled to the system to enable the data processing system to become coupled to other data processing systems or storage devices through intervening private or public networks. Modems, cable modem and Ethernet cards are just a few of the currently available types of network adapters.

It is understood that the specific order or hierarchy of steps in the foregoing disclosed methods are examples of exemplary approaches. Based upon design preferences, it is understood that the specific order or hierarchy of steps in the method can be rearranged while remaining within the scope of the present invention. The accompanying method claims present elements of the various steps in a sample order, and are not meant to be limited to the specific order or hierarchy presented.

It is believed that the present invention and many of its attendant advantages is to be understood by the foregoing description, and it is apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A method of creating a quiet zone, comprising steps of:
receiving, by a source system, a request for creating a quiet zone;
generating, by the source system, a quiet time data packet including data specifying a start and duration of a quiet time;
transmitting the quiet time data packet to at least one destination system; and
receiving the quiet time data packet by the at least one destination system so that the at least one destination system may implement the quiet time for the specified duration.

2. The method of creating a quiet zone as claimed in claim 1, wherein the quiet time data packet is a binary packet and the packet is transmitted by use of a network protocol.

3. The method of creating a quiet zone as claimed in claim 1, further comprising a step of sending a cancellation data packet from the source system to the at least one destination system to terminate the quiet time prior to the expiration of the set duration.

4. The method of creating a quiet zone as claimed in claim 1, wherein the at least one destination system is a plurality of destination systems all of which are placed into the quiet time by a single request for a quiet zone.

5. The method of creating a quiet zone as claimed in claim 1, wherein the source system is a system of an on-line quiet time provider.

6. The method of creating a quiet zone as claimed in claim 5, wherein the system of the on-line provider is selected from the group consisting of an Internet Service provider, a telephone-service provider, and a cable television provider.

7. The method of creating a quiet zone as claimed in claim 6, wherein the at least one destination system is at least one of a bluetooth paired device.

8. The method of creating a quiet zone as claimed in claim 1, wherein the quiet time data packet includes a user specific identification code which is recognizable by the at least one destination system to protect the at least one destination system from unauthorized requests.

9. A computer program product comprising:
a computer useable medium including computer usable program code for creating a quiet zone, the computer program product including:
computer usable program code for receiving a request for creating the quiet zone;
computer usable program code for generating a quiet time data packet, the quiet time data packet being generated by a source system and including data specifying a start and duration of a quiet time;
computer usable program code for broadcasting the quiet time data packet to at least one destination system; and
computer usable program code for receiving the quiet time data packet by the at least one destination system so that the at least one destination system may implement the quiet time for the specified duration.

10. The computer program product as claimed in claim 9, wherein the quiet time data packet is a binary packet and the packet is transmitted by use of a network protocol.

11. The computer program product as claimed in claim 9, wherein computer program product further comprises computer usable program code for sending a cancellation data packet from the source system to the at least one destination system to terminate the quiet time prior to the expiration of the set duration.

12. The computer program product as claimed in claim 9, wherein the at least one destination system is a plurality of destination systems all of which are placed into a quiet time mode by a single request for a quiet zone.

13. The computer program product as claimed in claim 9, wherein the source system is a system of an on-line quiet time provider.

14. The computer program product as claimed in claim 9, wherein the system of the on-line provider is selected from the group consisting of an Internet Service provider, a telephone-service provider, and a cable television provider.

15. The computer program product as claimed in claim 9, wherein the at least one destination system is at least one of a bluetooth paired device.

16. A system for creating a quiet zone, comprising:
a source system for generating a quiet time data packet, the quiet time data packet including data specifying quiet time start and duration; and
at least one destination system communicatively coupled to the source system for allowing the source system to put the at least one destination system into a quiet time mode,
wherein the source system transmits the quiet time data packet to the at least one destination system upon entry of a single request for quiet time to the source system.

17. The system as claimed in claim 16, wherein the quiet time data packet is a binary packet and the packet is transmitted by use of a network protocol.

18. The system as claimed in claim 16, wherein the at least one destination system is at least one of a bluetooth paired device.

19. The system as claimed in claim 16, wherein the source system generates a cancellation data packet for terminating the quiet time prior to the expiration of the set duration.

20. The system as claimed in claim 16, wherein the source system is a system of an on-line quiet time provider.
